(19) United States
(12) Patent Application Publication
(10) Pub. No.: US 2009/0001197 A1
(43) Pub. Date: Jan. 1, 2009

(54) Hub and hub system for supporting and watering plants

(76) Inventor: Randolph DeArmond Dilday, Ellensburg, WA (US)

Correspondence Address: PATENT LAW & VENTURE GROUP, 2424 S.E. BRISTOL, SUITE 300, NEWPORT BEACH, CA, 92660, US

(21) Appl. No.: 11/973,168

(22) Filed: Oct. 5, 2007

Related U.S. Application Data
(60) Provisional application No. 60/937,303, filed on Jun. 26, 2007.
(60) Provisional application No. 60/962,710, filed on Jul. 30, 2007.

(51) Int. Cl. F16M 11/02; B05B 15/06

(52) U.S. Cl. 239/268; 248/177.1

(57) ABSTRACT

A unitary rigid hub having a central vertical axis of symmetry; the hub further providing an exterior surface and an interior surface. The interior surface defining at least three leg sockets wherein each one of the leg sockets is adapted for receiving a leg strut to extend the leg struts in a divergent pattern. The exterior surface defines at least one vertically oriented groove having opposing convergent side surfaces which may receive an arm strut wedged therein. Spaced apart hubs may jointly hold the arm struts in their grooves to form a bridge between them and may therefore form a network of such hubs and bridges. A water fitting within the hubs provides disbursement of water to sprinklers and water delivery tubes. The hubs may be used as a plant support wherein the plants may be watered more uniformly.

### CROSS-REFERENCE TO RELATED APPLICATIONS

This application is a non-provisional application describing the same invention as two non-expired provisional applications, Ser. No. 60/937,303, filed on Jun. 26, 2007, and Ser. No. 60/962,710 filed on Jul. 30, 2007 and which are hereby incorporated by reference herein, the present application claiming date priority to the earliest filing date of Jun. 26, 2007.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates specifically to garden arbors and trellises and more particularly to a modular plant supporting and watering system having spaced apart hubs mounted on legs and interconnected by horizontal strutz.

2. Description of Related Art including information disclosed under 37 CFR 1.97 and 1.98

Greenhalgh, U.S. Pat. No. 3,865,309, discloses a sprinkling fence constructed from one or more units having at least one rail connected to at least one upright post. The rail is in the form of a pipe provided with one or more orifices arranged for dispensing water, and the like. An anchor peg, which has a post receiving socket provided with a spike-shaped, ground-engaging element, secures the post in an upright position.

Nievelt, U.S. Pat. No. 4,213,272, discloses a device for use by gardeners in growing vines for raising tomatoes and other vine growing vegetables, consisting of a series of horizontal plates of a transparent material supported one above the other by a series of struts between the plates. The plates have central cut-out portions to provide room for vertical growth of the vine upwardly through successive plates. The plate structure is held in place by stakes embedded in the ground with their upper ends secured to the plates.

Harward, U.S. Pat. No. 4,824,020, discloses a lightweight vertical support stand for a water sprinkler head that comprises a central support hub and at least five flexible elongate legs attached to the support hub. The legs are pivotally attached so that they can be positioned in an extended support position or can be gathered in a bundle for moving and storage. The support stands for the water sprinkler heads are used in an agricultural irrigation system in which lateral water conduits are provided at spaced positions across the area to be irrigated. Quick disconnect couplings are provided in the lateral conduits, and the support stands and sprinkler heads are adapted to be quickly engaged with the couplings in the lateral conduits.

Stone, U.S. Pat. No. 4,922,653, discloses a plant watering and feeding support system that comprises at least three upstanding tubular stakes. Each stake has a lower end thereof planted in soil. The stakes each have a part located above a ground surface of the soil which is adapted with a connector for receiving ends of tubular cross members which extend therefrom in a horizontal plane and generally join the parts of the stakes located above the ground. Therefore, a horizontal liquid distribution network is defined. A liquid poured in at least a top end of one of the stakes thus distributes to the other stakes through the distribution network and to the soil downwardly by way of the stakes through the lower ends thereof. The plant is basically supported by the cross members. The connectors are adapted to receive at their upper ends the lower ends of vertical tubes which are provided at their upper ends with further connectors. Further tubular cross members join these further connectors to provide the watering and feeding support system with a further horizontal distribution network. The number of levels of the support system is dependent upon the height of the plant and its ability to support itself.

Sihold, U.S. Pat. No. 4,942,693, discloses an adjustable arbor-like umbrella construction by which the umbrella may be adapted to a variety of locations and supports real and/or artificial plants or tree branches in order to provide shade in an aesthetically pleasing manner. In an exemplary embodiment, the umbrella of the present invention includes a center pole, a central hub support atop the pole, and a plurality of lattice assemblies radiating from the support hub and being rotatably attached thereto. Each of the lattice assemblies is formed of a plurality of slats pivotally connected to one another. Since each lattice assembly may be rotated with respect to the support hub and each slat of each lattice assembly may be pivoted with respect to an adjacent slat, the umbrella can be arranged in not only a variety of circular shapes of varying diameter, but also in a multiple of non-circular shapes to accommodate its use, for example, up against a wall, around a corner, in a corner, or to suit a particular taste.

Bussiere, U.S. Pat. No. 5,439,176, discloses a rotary oscillating irrigation sprinkler head that is supported in a stable elevated position above the ground surface, such that the sprinkler assembly can be used on a lawn or in garden foliage. A tripod support structure is connected at its upper end to a vertical water supply pipe that connects with the sprinkler head, so that the sprinkler head has a stabilized support above the ground surface. The water supply pipe delivers a pressurized stream of water to the sprinkler head.

Van Epps et al., U.S. Pat. No. 5,836,516, discloses a portable water sprinkler system that includes a central water column assembly having a lower section, an upper section removably connected to the lower section, and a sprinkler head removably connected to the upper section. The lower section includes an outer tube formed of galvanized steel, an inner tube formed of plastic for supplying water to the upper section, and a hose connector at the lower end for receiving a hose for supplying water to the inner tube. The upper section is formed of plastic and is removably connected to the inner tube of the lower section. The outer tube of the lower section includes three connection flanges formed of galvanized steel extending outwardly from the outer tube. The portable water sprinkler system further includes first, second, and third leg members formed of galvanized steel being pivotally connected at their upper ends to the three connection flanges on the outer tube, respectively. In addition, the portable water sprinkler system includes first, second, and third horizontally disposed feet members for engaging the ground to support the sprinkler system and being connected to the lower ends of the first, second, and third leg members, respectively. The lower section further includes a second outer tube formed of galvanized steel that is slidably disposed on the inner tube. Further, the second outer tube includes three connection flanges extending outwardly from the second outer tube.

Dean, U.S. Pat. No. 5,913,477, discloses a plant support and irrigation system for domestic and commercial use that is assembled without tools from two principal interlocking components, i.e., tubular members and hubs, to form modules. Modules are joined in mating relation vertically, horizontally and/or at varying angles to construct a variety of useful plant support structures including, for example, A-frames, trellises, arbors and fences and other forms of enclosures. The horizontal and/or vertical components of the modules are optionally perforated tubing making the structures capable of providing low-pressure drip or spray irrigation for the supported plants. The assembly can include connecting members of varying angles, plugs and valved hose connections configured to securely mate with one or both ends of the tubular members.

Hsu, U.S. Pat. No. 6,322,027, discloses an adjustable sprinkler stand that includes a sprinkler mount which is supported by three support rod sets and is provided with a threaded through hole for engaging at the top end thereof with a sprinkler and at the bottom end thereof with a water supply tube in conjunction with a connection seat slidably fitted over the water supply tube. The support rod sets are adjustable and formed of an outer tube, an inner tube slidably fitted into the outer tube, and a leg tube fitted into the inner tube. The outer tube and the inner tube are provided with a locating member which is pivoted with one end of a connection rod such that other end of the connection rod is fastened pivotally to the connection seat.

It is clear from Harward, Hsu, Bussiere and Van Epps et al, that stands for elevating garden sprinklers is well known in the art. Such stands may have tripod like leg arrangements and water is supplied from below by hose connections. Also well known in this field are stands such as arbors and trellises that are used for supporting plants as shown by Nievelt and Sibold. Finally, stands or like structures for supporting plants, while also providing watering are known in the art as exemplified by Dean, Stone and Greenhalgh. However, as will be pointed out in detail, the present invention clearly distinguishes over the cited art individually and in combination providing heretofore unknown advantages as described in the following summary.

### BRIEF SUMMARY OF THE INVENTION

This disclosure teaches certain benefits in construction and use which give rise to the objectives described below.

The present invention is an improved plant support and watering system based on a novel structural hub apparatus. The hub is a molded, stamped, machined, cast or otherwise manufactured part that is able to receive support legs for elevating the hub and its internal water processing elements. It also is able to support one end of a beam that connects the hub to another similar hub placed distally from the first one. In this manner, the hub design is able to establish watering nodes in a matrix of plant supporting structures. The prior art teaches structures for supporting plants and also for watering the supported plants; see the Greenhalgh, Stone and Dean references. However, the prior art structures fail to provide an open ended system for two dimensional expansion of the support/watering system. In contrast, the instant invention enables unlimited expansion of a support/watering system in two dimensions and with whatever shape is desired. To enable this type of expansion, the hubs provide grooves for receiving cross beams that may extend outwardly in whatever direction is desired. The hubs may be formed in any polygonal shape desired, with, for instance, four sides enabling expansion in four directions, pentagonal for five direction expansion, hexagonal for six direction expansion, and so on. Four sided hubs are illustrated herein, but other shapes are clearly within the context of the present description and claims.

A primary objective inherent in the above described apparatus and method of use is to provide advantages not taught by the prior art.

Another objective is to provide a garden support/watering system that enables a large number of expansion configurations over a two dimensional field.

A further objective is to provide such a system that is able to be assembled, disassembled and reconfigured without fasteners or tools.

A further objective is to provide such a system that provides elevated garden irrigation, selectable sprinkler height, support for climbing plants and drip irrigation.

A further objective is to provide such a system that may be used as a trellis, garden screen, boundary fence, cold frame, or small greenhouse structure.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus;

FIG. 2 is a top plan view thereof;

FIG. 3 is a perspective view of a hub mounted on leg struts, thereof;

FIG. 4 is a top plan view of the hub with upper portions of the leg struts of FIG. 3;

FIG. 5 is a vertical section taken along cutting line 5-5 in FIG. 4; and

FIG. 6 is a vertical section taken along cutting line 6-6 in FIG. 4.

### DETAILED DESCRIPTION OF THE INVENTION

The above described drawing figures illustrate the described apparatus and its method of use in at least one of its preferred, best mode embodiments, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

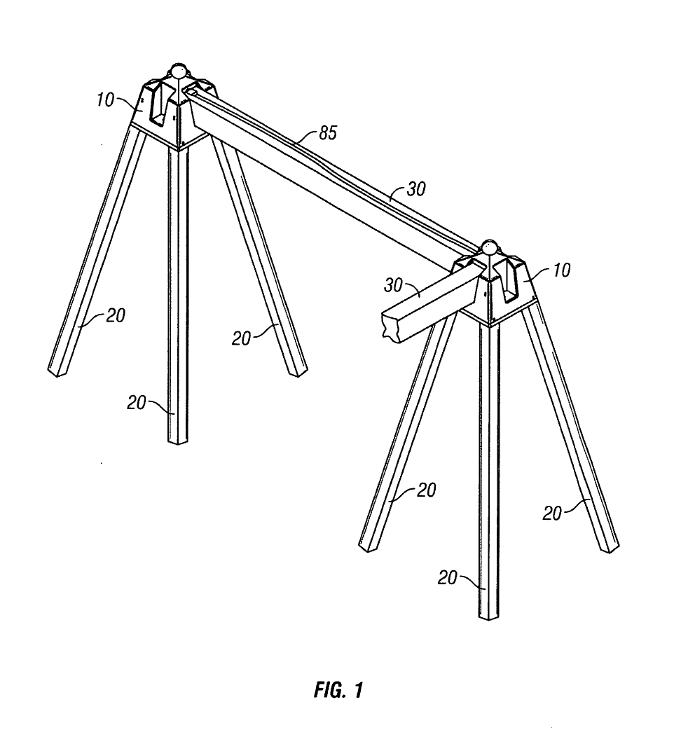

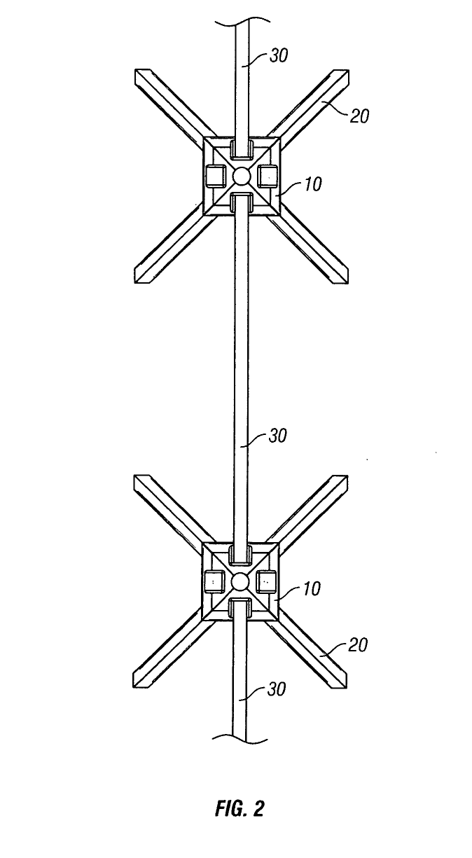

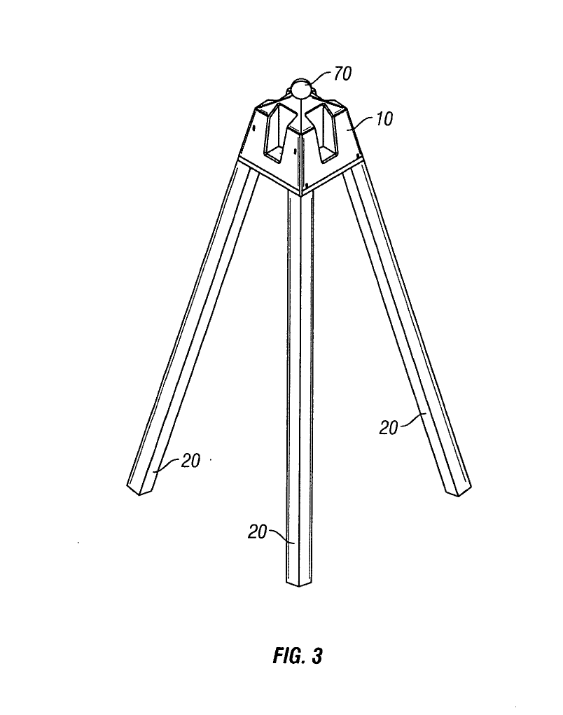

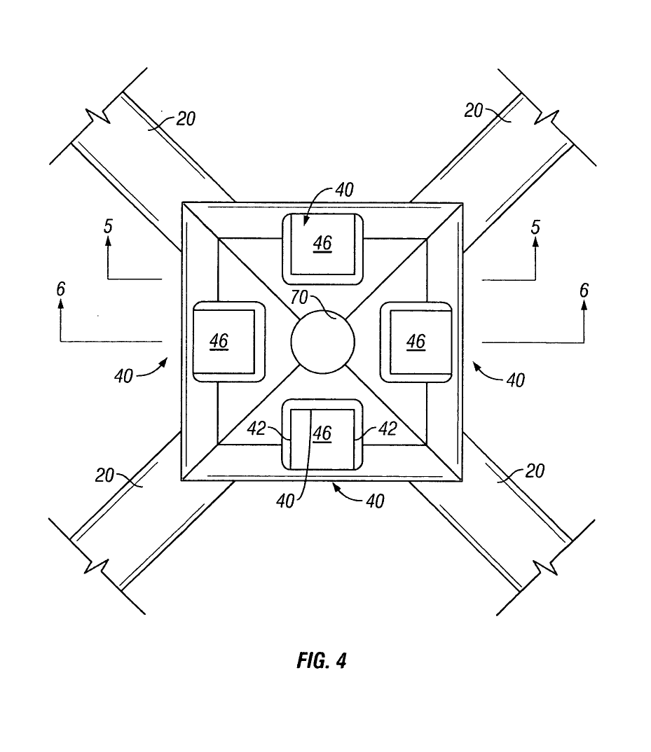

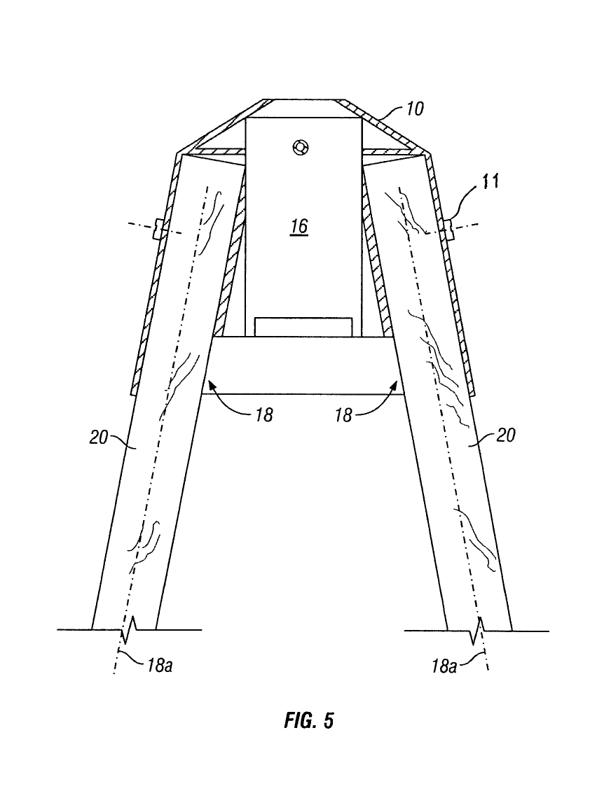

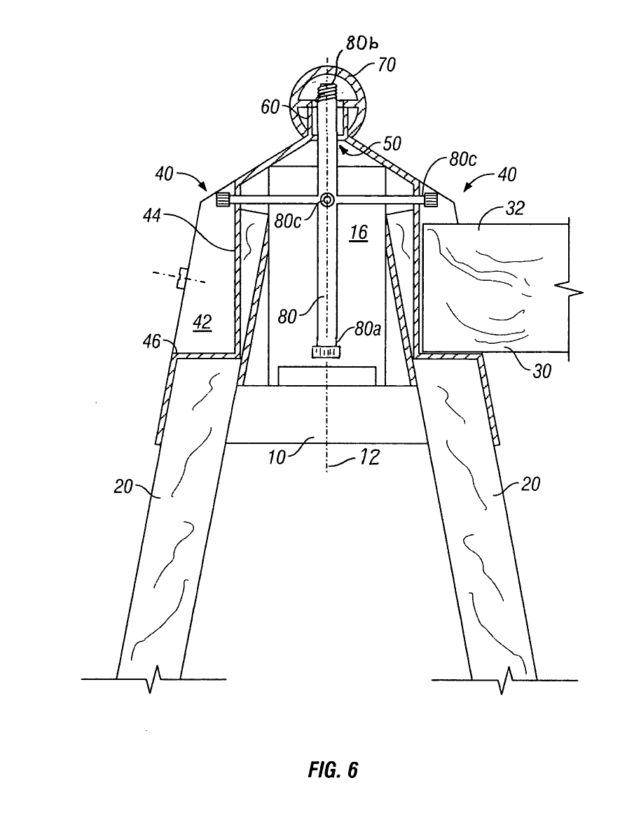

Described now in detail are three embodiments of the present invention. In a first embodiment, a square hub 10 is adapted for use with leg struts 20 and arm struts 30 as shown in FIGS. 1 and 2. The hub 10 is formed as a one piece (unitary) rigid unit having a central vertical axis of symmetry 12 (FIG. 6), an exterior surface 14 (FIG. 4) and an interior surface 16 (FIG. 5). The interior surface 16 is shown with four leg sockets 18, but it may have three, four, or more leg sockets 18 wherein each one of the leg sockets 18 is adapted by its size, shape and extent, for receiving and engaging one of the leg struts 20 in compressive engagement. Longitudinal axes 18a of the leg sockets 18 preferably extend away from the hub 10 in a divergent pattern so that the leg struts 20 may be used for standing the hub 10 on a surface such as in a garden, with stability. The hub 10 may be constructed with three sides, four sides (shown) or more than four sides, or as a smoothly continuous conical shape, or other shape, and from any structural material that results in a rigid and durable part; not degraded by sunlight or the elements. Preferably, the hub 10 is injection molded of a high strength engineering polymer with a UV resistant co-molded additive. UV resistance may be alternately obtained by coating the molded part with a UV protective agent. The exterior surface 14 preferably has at least one vertically oriented groove 40 and preferably provides one groove 40 between each pair of adjacent leg sockets 18, which is exemplified in FIG. 4. The groove 40 is defined by opposing convergent side surfaces 42, a back surface 44 and a bottom surface 46 see FIG. 4. These surfaces 42, 44, and 46 are arranged as shown and configured for receiving and wedgingly securing an end 32 of a horizontal arm strut 30, as best seen in FIG. 6. The hub 10 further defines an aperture 50 (FIG. 6) which is centered on the vertical axis of symmetry 12 and extends between the exterior 14 and the interior 16 surfaces. The exterior surface 14, as shown in FIG. 3, may be formed with a plurality of contiguous planes or flat surfaces, but may also be formed as primarily triangular, or other polyhedron shape, or may be configured as essentially spherical. A vertically oriented tube 60 is preferably integral with the hub 10 and extends upwardly from the exterior surface 14 in alignment with the aperture 50. A removable cap 70 may be rested over tube 60 or may be threadedly engaged with tube 60 for a more secure attachment. The tube 60 and cap 70 are functional as a closure, dust cover and gripping means as well as providing improved appearance to the hub 10. Section 6-6 of FIG. 4 is shown in FIG. 6. This figure show that hub 10 preferably incorporates a water fitting 80 aligned with the axis of symmetry 12 and engaged within the aperture 50. Fitting 80 is adapted for engaging water conduits or hoses, tubes and similar devices. Such devices, as for instance a water hose (not shown) may be attached to fitting 80 at its lower end 80a supplying water to fitting 80, and a sprinkler head (not shown) may be attached at its upper end 80b for distributing water to a garden area surrounding the hub 10. Fitting 80 may also have laterally extending portions 80c for delivering water to water lines 85 (FIG. 1) that may be rested on or fastened to the arm struts 30, and may also be conducted within longitudinal grooves in the surface of the arm struts 30, or may be conducted within the body of the arm struts 30. Such water lines 85 may also extend along leg struts 20 to watering devices for plants. Such lines may be extended to neighboring hubs 10 feeding sprinkler heads therein as shown in FIG. 1.

In a second embodiment, the apparatus comprises the hub 10, as described above in the first embodiment, in combination with the leg struts 20. The leg struts 20 are preferably lengths of dimensional milled wood products, extruded plastic or metal of various cross section sized such as: 1.5″, 2″ or 4″ square. However, the leg struts 20 may also be round stock wood, plastic or metal rod or tube. The leg sockets 18 are of such size as to receive a corresponding leg struts 20 in a tight compressive fit such that the struts 20 are tightly secured, but may be removed at a later time as desired. Alternately, the legs struts 20 may be secured within the hub 10 by screws 11, but if the strut size is matched to the sockets 18 properly, no screws 11 are necessary. Sockets 18 may be tapered or have a sequence of axially aligned reductions to accept a range of leg strut sizes. The length of the legs struts 20 may be custom cut so as to position the hub 10 at a desired vertical height above the supporting ground level when the distal end of the leg struts 20 are in contact with the ground surface. The leg struts 20 may be anchored to the ground or not. When anchored, they may be engaged by any means whatsoever, including: ground staples, stakes, concrete footings, and partial burial.

In a third embodiment, the apparatus comprises a pair of spaced apart hubs 10, each as described above in the second embodiment, i.e., mounted on leg struts 20. The hubs 10 may be separated by any distance that is desired by the user. It is clear that more than two such hubs 10 may be configured together using the arm struts 30. In this embodiment, a horizontally extending arm strut 30 is engaged wedgingly at its terminal ends within opposing vertically oriented grooves 40 of a pair of spaced apart hubs 10. This forms a bridge between the hubs 10 as shown in FIG. 1. As shown in FIG. 2 the arrangement of hubs 10, joined by arm struts 30, may be elaborate.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An apparatus for use with leg and arm struts, the apparatus comprising: a unitary rigid hub having a central vertical axis of symmetry; the hub further providing an exterior surface and an interior surface; the interior surface defining at least three leg sockets wherein each one of the leg sockets is adapted for receiving a leg strut, axes of the leg sockets extending away from the hub in a divergent pattern; the exterior surface defining at least one vertically oriented groove defined by opposing convergent side surfaces configured for receiving and wedgingly securing an end of a horizontally extending arm strut; the hub further defining an aperture centered on the vertical axis and extending between the exterior and the interior surfaces.

2. The apparatus of claim 1 wherein the hub provides a plurality of said grooves, one said groove positioned between each pair of adjacent leg sockets.

3. The apparatus of claim 1 wherein the exterior surface of the hub comprises a plurality of contiguous planes.

4. The apparatus of claim 1 further comprising a tube, engaged with and extending upwardly from the exterior surface in alignment with the aperture.

5. The apparatus of claim 4 further comprising a cap engaged with the tube.

6. The apparatus of claim 1 further comprising a water fitting aligned with and engaged with the aperture, the fitting adapted for receiving water conduit connectors.

7. The apparatus of claim 6 wherein the water fitting is adapted for engaging at least one of: a water disbursing device above the hub and a water disbursing device adjacent at least one of the grooves.

8. An apparatus comprising in combination: a unitary rigid hub having a central vertical axis of symmetry; the hub further providing an exterior surface and an interior surface; the interior surface defining at least three leg sockets wherein each one of the leg sockets engages a leg strut, the leg struts extending away from the hub in a divergent pattern; the exterior surface defining a vertically oriented groove defined by opposing convergent side surfaces adapted for engaging and wedgingly securing an end of a horizontally extending arm strut; the hub further defining an aperture centered on the vertical axis and extending between the exterior and the interior surfaces.

9. The apparatus of claim 8 wherein the hub provides a plurality of said grooves, one said groove positioned between each pair of adjacent leg sockets.

10. The apparatus of claim 8 wherein the exterior surface of the hub comprises one of a plurality of contiguous planes and a conical surface.

11. The apparatus of claim 8 further comprising a tube, engaged with and extending upwardly from the exterior surface in coaxial alignment with the aperture.

12. The apparatus of claim 11 further comprising a cap engaged with the tube.

13. The apparatus of claim 8 further comprising a water fitting aligned with and engaged with the aperture, the water fitting adapted for receiving water conduit terminations.

14. The apparatus of claim 13 wherein the water fitting is adapted for engaging at least one of: a water disbursing device positioned above the hub, and a water disbursing device positioned adjacent at least one of the grooves.

15. An apparatus comprising in combination: at least two unitary rigid hubs, each having a central vertical axis of symmetry; and further providing an exterior surface and an interior surface; the interior surface defining at least three leg sockets wherein each one of the leg sockets engages a leg strut, the leg struts extending away from the hub in a divergent pattern; the exterior surface defining at least one vertically oriented convergent groove; a horizontally extending arm strut engaged wedgingly at ends thereof with the grooves of two of the hubs thereby forming a bridge between the two of the hubs.

16. The apparatus of claim 15 wherein each of the pair of spaced apart hubs provides an aperture centered on the vertical axis and extending between the exterior and the interior surfaces.

17. The apparatus of claim 15 wherein at least one of the pair of spaced apart hubs provides a plurality of said grooves, with one said groove positioned between each pair of adjacent leg sockets.

18. The apparatus of claim 16 wherein at least one of the pair of spaced apart hubs further comprises a tube, engaged with and extending upwardly from the exterior surface in alignment with the aperture.

19. The apparatus of claim 18 wherein at least one of the pair of spaced apart hubs further comprises a cap engaged with the tube.

20. The apparatus of claim 16 wherein at least one of the pair of spaced apart hubs further comprises a fitting aligned and engaged with the aperture, the fitting adapted for receiving water conduit terminations and further adapted for engaging at least one water disbursing device.
